(19) United States
(12) Patent Application Publication
(10) Pub. No.: US 2011/0150074 A1
(43) Pub. Date: Jun. 23, 2011

(54) TWO-PASS ENCODER

(75) Inventors: Limin Wang, San Diego, CA (US); Yinqing Zhao, Palo Alto, CA (US)

(73) Assignee: GENERAL INSTRUMENT CORPORATION, Horsham, PA (US)

(21) Appl. No.: 12/645,688

(22) Filed: Dec. 23, 2009

(51) Int. Cl. H04N 7/26

(52) U.S. Cl. 375/240.02; 375/E07.126

(57) ABSTRACT

A two-pass encoder includes a first encoding module and a second encoding module. The first encoding module is configured to encode an input video sequence in a first pass, and to determine coding decisions from the first pass. The second encoding module is configured to encode the input video sequence using the coding decisions from the first encoding module in a second pass, and to output a second pass encoded stream. At least one of the first encoding module and the second encoding module is a partial encoding module.

### BACKGROUND

ITU-T H.264/MPEG-4 part 10 is a recent international video coding standard, developed by Joint Video Team (JVT) formed from experts of International Telecommunications Union Telecommunication Standardization Sector (ITU-T) Video Coding Experts Group (VCEG) and International Organization for Standardization (ISO) Moving Picture Experts Group (MPEG). ITU-T H.264/MPEG-4 part 10 is also referred to as MPEG-4 AVC (Advanced Video Coding). MPEG-4 AVC achieves data compression by utilizing the advanced coding tools, such as spatial and temporal prediction, blocks of variable sizes, multiple references, integer transform blended with quantization operation, entropy coding, etc. MPEG-4 AVC supports adaptive frame and field coding at picture level. MPEG-4 AVC is able to encode pictures at lower bit rates than older standards but maintain at least the same quality of the picture.

Single pass encoding is known for encoding of input video sequences to form MPEG-4 AVC streams. For video coding of input sequences using MPEG-4 AVC, it is ideal to have information on coding statistics of both past and future pictures. By using the coding statistics, an encoder is better able to distribute an available bit budget over pictures and therefore achieves better overall coding performance. However, a single pass encoder is not configured to provide the coding statistics, but in a two-pass encoder, a first full encoder may provide the coding statistics from a first pass for a second full encoder to encode the MPEG-4 AVC stream in a second pass. However, a two-pass encoder consisting of two independent full encoders can be very costly because of the cost of selecting the best coding modes at different coding stages. Coding modes in MPEG-4 AVC include frame and field modes at picture level, frame and field modes at macro-block level, and intra and inter modes at macroblock level.

For example, selecting or determining coding modes at different coding stages may be based on a Lagrangian rate and distortion (RD) cost function at different coding stages to select a coding mode at different stages. For each coding mode, in order to calculate the RD cost function, an MPEG-4 AVC encoder has to perform a complete encoding and decoding, including performing coding operations such as prediction, sub/add, transform/quantization, dequantization/inverse transform, entropy coding, etc. Because of all the operations that need to be performed to determine the RD cost function for each coding mode, it is very costly in terms of processing resources and time to select a coding mode that minimizes the RD cost. Thus, the two-pass encoder consisting of two independent full encoders using the RD cost function in both the first pass and the second pass to make coding mode decisions may be infeasible for applications requiring real-time encoding.

### SUMMARY

Disclosed herein is a method for two-pass encoding an input video sequence to form a second pass encoded stream, according to an embodiment. In the method, the input video sequence is encoded in a first pass using a first encoding module. Coding decisions collected from the first pass are sent to and received at a second encoding module. The input video sequence is then encoded using the coding decisions from the first pass in a second pass. A second pass encoded stream is then output. At least one of the first encoding module and the second encoding module is a partial encoding module and the input video sequence is received at the first encoding module and with a delay at the second encoding module.

Also disclosed herein is a two-pass encoder, according to an embodiment. The two-pass encoder comprises a first encoding module and a second encoding module. The first encoding module is configured to encode the input video sequence in a first pass, to determine coding decisions from the first pass, and to output the coding decisions to the second encoding module. The second encoding module is configured to encode the input video sequence using the coding decisions from the first encoding module in a second pass, and to output a second pass encoded stream. At least one of the first encoding module and the second encoding module is a partial encoding module and the input video sequence is received at the first encoding module and with a delay at the second encoding module.

Further, three embodiments of the two-pass encoder are disclosed herein. In a first embodiment, the two-pass encoder comprises a first full encoding module and a second partial encoding module. In a second embodiment, the two-pass encoder comprises a first partial encoding module and a second full encoding module. In a third embodiment, the two-pass encoder comprises a first partial encoding module and a second partial encoding module.

Still further disclosed is a computer readable storage medium on which is embedded one or more computer programs implementing the above-disclosed method for two-pass encoding an input video sequence according to an embodiment.

Embodiments of the present invention include a two-pass encoder that provides a balance between performance of a conventional two-pass encoder and comparatively low complexity of a single pass encoder. Embodiments of the invention may be used to provide rate control with a delay between a first pass and a second pass. By using the delay, coding statistics from the first pass may be used in determining target coding parameters for the second pass for rate control purposes. Additionally, because of the reuse of coding decisions and coding statistics, which includes decisions on coding modes and motion vectors (MVs), partial encoding used in the first pass or the second pass significantly reduces the encoding costs when compared to a two-pass encoder while providing a similar coding performance.

According to an embodiment, instead of using a RD cost function, a non RD cost function can be used to select coding modes. The non RD cost function needs less information to determine costs and also uses much less resources than the RD cost function. Also, the performance, even when using the non RD cost function as opposed to the RD cost function, has accuracy that is very close to a two-pass encoder comprised of two full encoders. Furthermore, accuracy for motion estimation (ME) is increased by using a result of full ME in a first pass as a starting point for performing ME refinement in the second pass.

### BRIEF DESCRIPTION OF THE DRAWINGS

Features of the present invention will become apparent to those skilled in the art from the following description with reference to the figures, in which:

FIG. 1 illustrates a simplified block diagram of architecture of a two-pass encoder, according to an embodiment;

FIG. 2 illustrates a functional block diagram of a two-pass encoder configured to encode an input video sequence, according to an embodiment;

FIG. 3 illustrates a diagram of a coding mode decision tree for encoding a sequence of pictures, according to an embodiment;

FIG. 4 illustrates a flow diagram of a method of encoding a picture, according to an embodiment;

FIG. 5 illustrates a flow diagram of a method of encoding a MB pair according to an embodiment;

FIG. 6 illustrates a flow diagram of a method of encoding a MB according to an embodiment;

FIG. 7 illustrates a flow diagram of a method of encoding a MB in inter mode according to an embodiment;

FIG. 8 illustrates a flow diagram of a method of encoding a picture in frame according to an embodiment;

FIG. 9 illustrates a flow diagram of a method of encoding a picture in field, according to an embodiment;

FIG. 10 illustrates a flow diagram of a method of encoding a picture in field according to an embodiment; and

FIG. 11 illustrates a flow diagram of a method of encoding a picture according to an embodiment.

### DETAILED DESCRIPTION

For simplicity and illustrative purposes, the present invention is described by referring mainly to exemplary embodiments thereof. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

### 1. Definitions

The term “MPEG-4 AVC stream,” as used herein, refers to a time series of bits into which audio and/or video is encoded in a format defined by the Motion Picture Experts Group for the MPEG-4 AVC standard. MPEG-4 AVC supports three picture/slice types. These picture types are I, P and B. I is coded without reference to any other picture (or alternately slice). Only spatial prediction is applied to I. P and B are temporally predictive coded. The temporal reference pictures can be any previously coded I, P and B. Both spatial and temporal predictions are applied to P and B. MPEG-4 AVC is a block-based coding method. A picture is divided into macroblocks (MB). An MB can be coded in either intra or inter mode. MPEG-4 AVC offers many possible partition types per MB depending upon the picture type of I, P and B.

Coding as used herein means encoding, and encoding and coding are used interchangeably.

The term “inter mode,” as used herein, refers to the encoding of a picture with reference to previously encoded pictures. There are four possible MB partition types for inter mode. They are inter_{—}16×16, inter_{—}16×8, inter_{—}8×16 and inter_{—}8×8. Each 8×8 block within an MB can be further divided into sub_MB partitions of inter_{—}8×8, inter_{—}8×4, inter_{—}4×8 or inter_{—}4×4. When in inter mode, each MB (or sub_MB) partition of 16×16, 16×8, 8×16, 8×8, 8×4, 4×8 or 4×4 can have its own motion vectors (MVs). Specifically, one (either forward or backward) MV is allowed per MB (or sub_MB) partition in P, and one (either forward or backward) or two (bidirectional prediction) MVs per MB (or sub_MB) partition is allowed per MB (or sub_MB) partition in B. In inter mode, each MB partition of 16×16, 16×8, 8×16 or 8×8 can have its own reference picture(s) (refldx), but the sub_MB partitions of 8×8, 8×4, 4×8 or 4×4 within an MB partition of 8×8 have to use the same reference picture. In B, MB partition of 16×16 and sub_MB partition of 8×8 can be in direct mode, where the MVs are derived from the co-located blocks. There are two types of direct mode. They are temporal and spatial direct modes. In addition, AVC allows adaptively switching between frame and field coding modes at picture level (pic AFF) and at MB pair level (MB AFF).

The term “intra mode,” as used herein, refers to the encoding of a picture only with reference to information contained within the picture and without reference to previously encoded pictures. In I pictures, all the MBs are coded in intra mode. Intra mode is coded using spatial prediction. There are three possible MB partition types for intra mode. They are intra_{—}4×4, intra_{—}8×8, and intra_{—}16×16. There are nine possible spatial prediction directions for intra_{—}4×4, nine for intra_{—}8×8, and four for intra_{—}16×16. In P and B pictures, an MB can be coded in either intra or inter mode. Intra mode coding in P and B pictures is identical to in I pictures. Inter mode is coded using temporal prediction.

The term “MPEG-4 AVC partial encoder or MPEG-4 AVC partial encoding module,” as used herein, refers to a device that may be used to encode an input video sequence, wherein elements of the process used in a conventional full MPEG-4 AVC encoder, used to encode an input video sequence, are eliminated, bypassed or reduced. The MPEG-4 AVC partial encoder may also be referred to herein as a partial encoder.

The term “frame mode,” as used herein, refers to a process of encoding two fields of a picture or a block jointly.

The term “field mode,” as used herein, refers to a process of encoding two fields of a picture or a block separately.

The term “macroblock,” as used herein, refers to a term used in video compression, which may represent a block of 16-by-16 pixels in a picture.

The term “motion estimation (ME),” as used herein, refers to the process of obtaining a MV or MVs and associated refldx.

The term “macroblock-adaptive frame/field coding (or MBAFF),” as used herein, refers to a video encoding feature that allows an encoder to encode a MB of a frame picture in either frame mode or field mode. A MB in frame mode or in field mode can be encoded in intra mode or in inter mode.

The term “picAFF decision,” as used herein, refers to a video encoding feature that allows an encoder to encode a picture in either frame mode or in field mode.

The term “frame/field decision,” as used herein, refers to a decision whether to encode a picture, or a MB pair using either frame mode or field mode.

### Architecture of Two-Pass MPEG-4 AVC Encoder

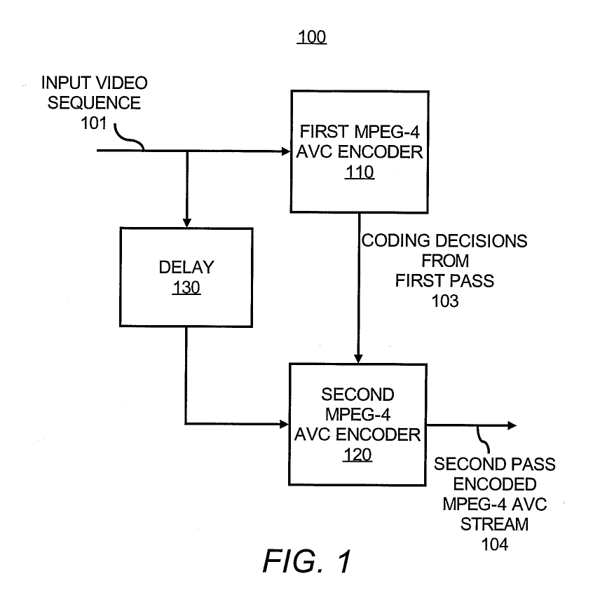

FIG. 1 illustrates a functional block diagram of a two-pass MPEG-4 AVC encoder 100 configured to encode an input video sequence 101 to form a second pass encoded MPEG-4 AVC stream 104. As shown in FIG. 1, a first MPEG-4 AVC encoding module 110 and a second MPEG-4 AVC encoding module 120 receive a same input video sequence 101 with a delay 130 between a first pass at the first MPEG-4 AVC encoding module 110 and a second pass at the second MPEG-4 AVC encoding module 120.

The two-pass MPEG-4 AVC encoder 100 may be used to provide rate control for the second pass encoded MPEG-4 AVC stream 104. The first pass may not output an MPEG-4 AVC stream, or alternately, the output MPEG-4 AVC stream from the first pass may not be output to an end user. Coding information from the first pass is instead used in the second pass for a purpose of rate control. For instance, coding statistics from the first pass may be used to determine target coding parameters for the second pass including bit allocation for each picture in the second pass. Although the two-pass MPEG-4 AVC encoder 100 is described with respect to MPEG-4 AVC, it should be apparent that embodiments of the invention may be used with different video coding standards.

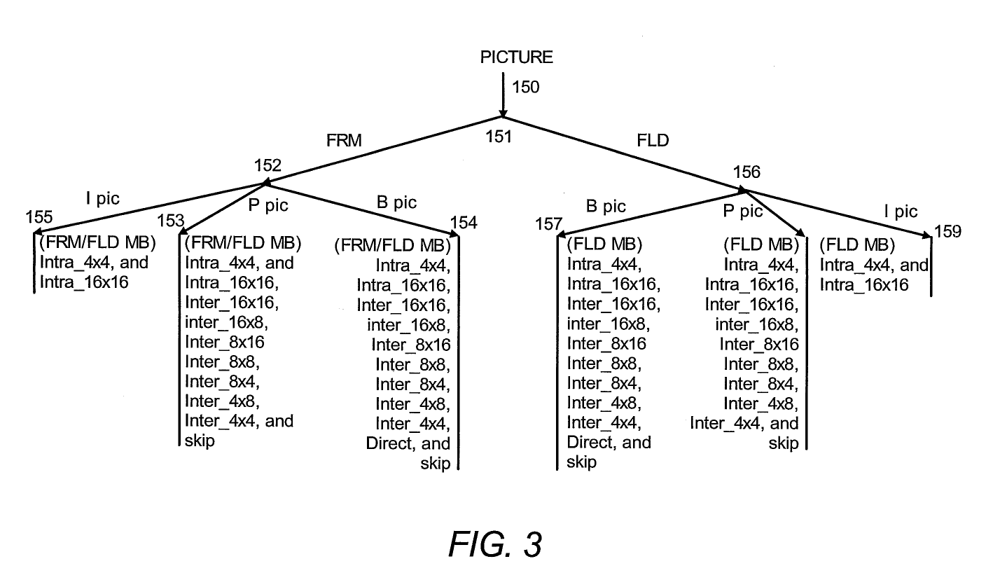

The first pass and the second pass are performed approximately in parallel with an offset provided by the delay 130. Coding decisions from the first pass 103 may thereby be used in the second pass as described hereinbelow with respect to FIGS. 3-10 and the methods 200-400. The coding decisions from the first pass 103 include, for example, coding mode decisions such as frame mode or field mode at a picture level and at a macroblock level. The first pass is ahead of the second pass by an approximately constant number of pictures, for example, the delay 130 may be 30 pictures. The delay 130 may also be measured in time, for instance 1 second.

For example, at a time the first pass processes a thirtieth picture in a consecutive sequence of pictures, the second pass processes a first picture in the consecutive sequence of pictures. Because the first pass is ahead of the second pass, the first pass may provide the coding decisions including coding statistics/coding information of the pictures to the second pass before the second pass starts to process the pictures. The coding statistics per picture may include quantization parameters used per MB and the number of bits generated per picture. Some of the coding decisions made in the first pass may be reused in the second pass, or used as starting points for the second pass. Additionally, the first pass may not generate or output the MPEG-4 AVC stream as a compressed bit stream, instead serving as a testing process for the second pass. The second MPEG-4 AVC encoding module 120 then outputs the second pass encoded MPEG-4 AVC stream 104.

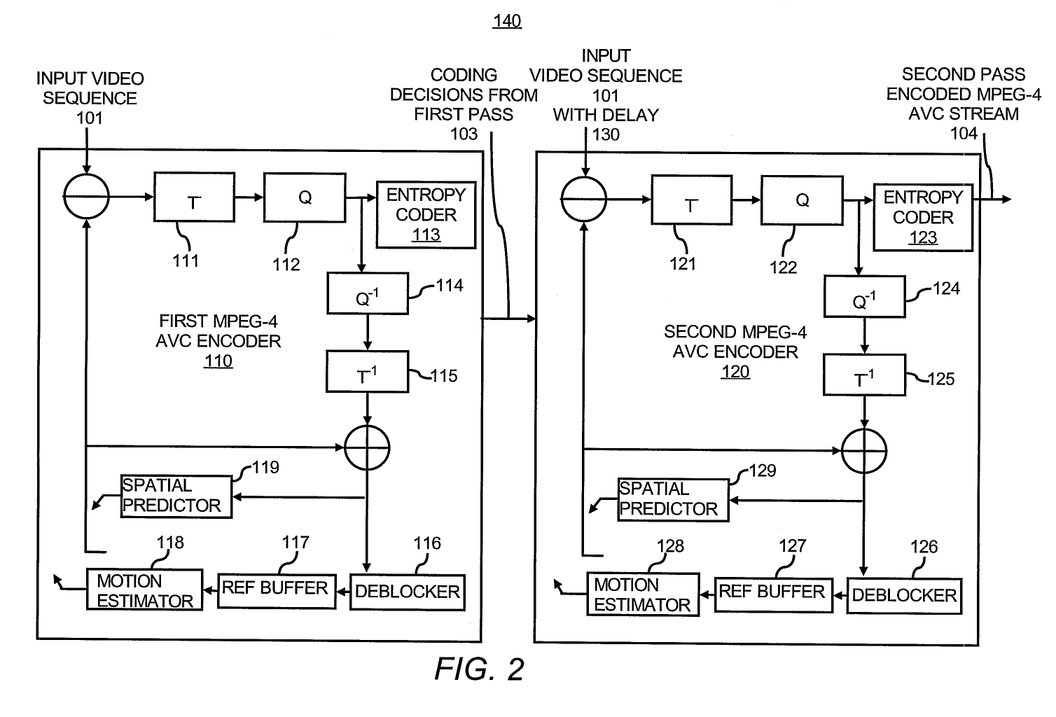

FIG. 2 illustrates a simplified block diagram of an architecture of the two-pass MPEG-4 AVC encoder 100 configured to encode an input video sequence 101. The two-pass MPEG-4 AVC encoder 100 includes the first MPEG-4 AVC encoding module 110 and the second MPEG-4 AVC encoding module 120. The two-pass MPEG-4 AVC encoder 100 is configured to encode the input video sequence 101 in the first pass and the input video sequence 101 with a delay 130 in the second pass using the first MPEG-4 AVC encoding module 110 and the second MPEG-4 AVC encoding module 120, respectively. The second MPEG-4 AVC encoding module 120 thereafter outputs the second pass encoded MPEG-4 AVC stream 104. The two-pass MPEG-4 AVC encoder 100 includes a circuit, for instance a processor, a memory or application specific integrated circuit (ASIC). It should be understood that the two-pass MPEG-4 AVC encoder 100 depicted in FIG. 2 may include additional components and that some of the components described herein may be removed and/or modified without departing from a scope of the two-pass MPEG-4 AVC encoder 100.

The first MPEG-4 AVC encoding module 110 and the second MPEG-4 AVC encoding module 120 comprise MPEG-4 AVC encoders. The first MPEG-4 AVC encoding module 110, and similarly the second MPEG-4 AVC encoding module 120, include components that may be used to encode an MPEG-4 AVC stream. For instance, the first MPEG-4 AVC encoding module 110 may include a transformer 111, a quantizer 112, an entropy coder 113, an inverse quantizer 114, an inverse transformer 115, a deblocker 116, a ref buffer 117, a motion estimator 118, and a spatial predictor 119.

By way of example, the transformer 111 is a block transform. The block transform is an engine that converts a block of pixels, whereby the block may be a partition of a macroblock, in the spatial domain into a block of coefficients in the transform domain. The block transform tends to remove spatial correlation among the pixels of a block. The coefficients in the transform domain are thereafter highly de-correlated. The quantizer 112 assigns coefficient values into a finite set of values. Quantization is a lossy operation and the information lost due to quantization cannot be recovered. The entropy coder 113 performs entropy coding, which is a lossless coding procedure that removes statistical redundancy in input sequences. The inverse quantizer 114 performs the reverse operation to the quantizer 112, assigning a finite set of values into coefficient values. The inverse transformer 115 performs an inverse transform from a block of coefficients in the transform domain to a block of pixels in the spatial domain. The deblocker 116 is a filter used for smoothing block boundaries. The ref buffer 117 holds data for temporal reference during the encoding process. The ME 118 is used for ME operations. The spatial predictor 119 performs predictions in pixel domain or spatial domain.

The components 111-119 of the first MPEG-4 AVC encoding module 110 may comprise software modules, hardware modules, a combination of software and hardware modules, or an ASIC. Thus, in one embodiment, one or more of the modules 111-119 comprise circuit components. In another embodiment, one or more of the modules 111-119 comprise software code stored on a computer readable storage medium, which is executable by a processor. In another embodiment, the modules 111-119 comprise an ASIC. Similarly, the second MPEG-4 AVC encoding module 120 includes modules 121-129 that may perform the same functions as modules 111-119 of the first MPEG-4 AVC encoding module 110.

As will be described with respect to methods 200-400 hereinbelow, at least one of the first MPEG-4 AVC encoding module 110 and the second MPEG-4 AVC encoding module 120 perform as a partial encoder in the two-pass MPEG-4 AVC encoder 100. The partial encoder avoids performing all coding operations, such as prediction sub/add, transform/quantization, dequantization/inverse transform, etc. In one embodiment, partial encoding is only performing full-pel ME per MB partition in inter mode rather than quarter-pel ME per MB partition in inter mode. Quarter-pel refers to a quarter of a standard pixel. The first MPEG-4 AVC encoding module 110 is also configured to collect coding decisions from the first pass 103. The second MPEG-4 AVC encoding module 120 is configured to receive the input video sequence with the delay 102 and to encode the input video sequence with the delay 102 using the coding decisions from the first pass 103.

It will be apparent that the two-pass MPEG-4 AVC encoder 100 may include additional elements not shown and that some of the elements described herein may be removed, substituted and/or modified without departing from the scope of the two-pass MPEG-4 AVC encoder 100. It should also be apparent that one or more of the elements described in the embodiment of FIG. 2 may be optional.

Examples of methods in which the two-pass MPEG-4 AVC encoder 100 may be employed to encode an input video sequence now be described with respect to the following flow diagrams of the methods 200-400 depicted in FIGS. 3-11. It should be apparent to those of ordinary skill in the art that the methods 200-400 represents a generalized illustration and that other steps may be added or existing steps may be removed, modified or rearranged without departing from the scopes of the methods 200-400. In addition, the methods 200-400 are described with respect to the two-pass MPEG-4 AVC encoder 100 by way of example and not limitation, and the methods 200-400 may be used in other systems.

Some or all of the operations set forth in the methods 200-400 may be contained as one or more computer programs stored in any desired computer readable medium and executed by a processor on a computer system. Exemplary computer readable media that may be used to store software operable to implement the present invention include but are not limited to conventional computer system RAM, ROM, EPROM, EEPROM, hard disks, or other data storage devices.

The two-pass MPEG-4 AVC encoder 100 is configured with at least one of the first MPEG-4 AVC encoding module 110 and the second MPEG-4 AVC encoding module 120 performing as a partial encoder. Disclosed herein are the following embodiments. It should be apparent to those of ordinary skill in the art that the embodiments represent generalized illustrations and are described by way of example and not limitation.

According to a first embodiment, as described with respect to the methods 200, 210, 220, and 240, the first MPEG-4 AVC encoding module 110 is a full encoder and the second MPEG-4 AVC encoding module 120 is a partial encoder. The first pass in the first embodiment is a full pass and the second pass is a partial pass. According to a second embodiment, as described with respect to the method 300, the first MPEG-4 AVC encoding module 110 is a partial encoder and the second MPEG-4 AVC encoding module 120 is a full encoder. The first pass is a partial pass and the second pass is a full pass. According to a third embodiment, as described with respect to the method 400, both the first MPEG-4 AVC encoding module 110 and the second MPEG-4 AVC encoding module 120 are partial encoders. Additionally, both the first pass and the second pass are partial passes.

### 3. Coding Mode Decisions for MPEG-4 AVC

FIG. 3 illustrates coding mode decisions for different coding stages for MPEG-4 AVC. The coding mode decisions are shown in a tree structure. These coding mode decisions are made for full-pass and partial-pass coding described below. The coding mode decisions shown in the tree are made by the encoding modules shown in FIG. 1 and further described below.

An RD or non-RD cost function may be used to determine a coding cost at code mode decision.

The RD cost function uses a complete set of coded information per coding mode, defined as J=D+λ×R, where D is the coding distortion (e.g. sum of square error in spatial domain), R is the bits and λ is a variable depending upon the quantization parameter, picture type, etc. Further, for each coding mode, in order to calculate the associated RD cost, an MPEG-4 AVC encoder has to perform a complete encoding and decoding, including coding operations such as prediction, sub/add, transform/quantization, dequantization/inverse transform, entropy coding, etc. Because of all the operations that need to be performed to determine the RD cost function for each coding mode, the use of RD cost function is very costly in terms of processing resources and time. Furthermore, the two-pass encoder consisting of two independent full encoders using the RD cost function in both the first pass and the second pass to make coding mode decisions may be infeasible for applications requiring real-time encoding.

The non-RD cost function, in contrast, needs only partial coded information per coding mode. The non-RD cost function is in a general form as J=SAD+λ×f(DMV,refldx,picType,mbType,etc.), in which SAD is a difference measure between the original pixels and their predictions (intra or inter prediction), λ is a variable dependent upon the quantization parameter, DMV is the difference of the true motion vectors and their predictions, refldx is the reference picture index per MB partition, picType is picture type, and mbType is the MB partition type. The non-RD method uses only partially coded information for mode decisions, and avoids performing all the coding operations, such as prediction sub/add, transform/quantization, dequantization/inverse transform, etc.

At 150, a picture of the input video sequence 101 is received.

At 151, a frame or field coding mode is selected for the picture. Selection may be based upon coding costs of encoding the picture in frame and field. A lower coding cost mode is selected.

At 152, assuming frame coding at the picture level was selected based on the cost analysis, the type of picture is determined, such as whether the received picture at 150 is I, P, or B. If the picture is P or B, then coding costs for both frame coding and field coding per MB pair are determined at 153 and 154. An MB pair is a pair of MBs in the picture. The MBs in the pair are next to each other.

After frame or field coding per MB pair is selected, each MB of the MB pair may select its own code mode, including inter, intra, skip and direct mode based on coding costs. For example, for each of two MBs within a MB pair a coding cost is determined for each intra mode, for each inter mode, for skip mode, and for direct mode. The lowest coding cost is selected which is associated with one of the inter or intra modes or the skip mode or the direct mode (if applicable) for frame or field. Skip mode and direct mode are described in the MPEG-4 AVC standard. Thus, based on the coding cost calculations, the encoding module selects frame or field mode for a MB pair, and selects one of the intra or inter modes or the skip mode or the direct mode that is lowest cost for each MB within the MB pair.

Note that at 153 and 154, the coding cost calculations are performed for each MB pair as well as for each MB within a MB pair in the picture. Thus, frame mode may be selected for one MB pair and field mode may be selected for another MB pair. The same or different code modes may be selected for the two MBs of the MB pair.

At 155, if the picture is an I picture, coding cost calculations for each MB pair in frame and field modes and for each MB of a MB pair in allowable intra modes are performed. The mode with the lowest coding cost is selected for each MB and for each MB pair.

At 151, if the field mode is selected at the picture level, then coding cost calculations are performed at 156-159 similar to as described with respect to 152-155, except frame and field decision at MB pair level. The mode with the lowest coding cost may then be selected for each MB in the field mode. Note that in field mode there is a top field picture and a bottom field picture. The coding cost is determined for each picture and for each MB in each picture rather than per MB pair.

### 4. First Pass Full Encoder Second Pass Partial Encoder

In the first embodiment, as described with respect to the methods 200-240, and FIGS. 2-6, the two-pass MPEG-4 AVC encoder 100 is configured with the first MPEG-4 AVC encoding module 110 as a full encoder and the second MPEG-4 AVC encoding module 120 as a partial encoder. The methods 200-240 pertain to the second pass performed by the second MPEG-4 AVC encoding module 120. In this embodiment, the first pass uses the full decision tree, as described in FIG. 3 to make coding mode decisions and the second pass reuses some of coding mode decisions from the first pass.

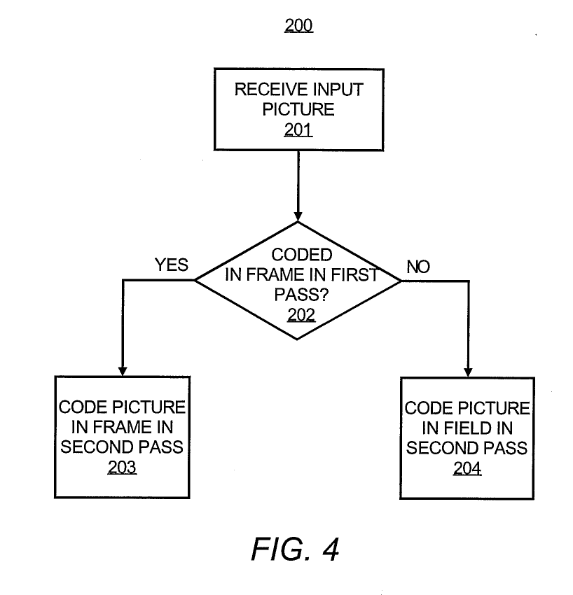

The following methods indicate that coding decisions made in the first pass are reused for the partial encoding in the second pass in different embodiments. The re-using of coding decisions is described in methods 200, 210, 220 and 240 of FIGS. 4-7.

In the method 200, as shown in FIG. 4, the second MPEG-4 AVC encoding module 120 reuses a picAFF decision (i.e., a decision whether to encode a picture using frame coding or field coding) from the first pass for an I, P, or B picture. The method 200 and other methods described herein are described with respect to the encoding architecture shown in FIG. 1 by way of example and not limitation and the methods may be performed by other encoders.

At step 201, the second MPEG-4 AVC encoding module 120 receives an input picture. This is an input picture that has been previously encoded in the first pass. The input picture is part of an input video sequence that is received with a delay at the second MPEG-4 AVC encoding module 120 as compared to the first MPEG-4 AVC encoding module 110.

At step 202, the second MPEG-4 AVC encoding module 120 determines whether the input picture was encoded in frame coding in the first pass. The coding decisions from the first pass may be provided in meta data from the first pass.

At step 203, if the input picture is coded in frame coding in the first pass, it is coded in frame coding in the second pass as well.

At step 204, if the input picture is coded in not coded in frame, and therefore coded in field coding in the first pass, it is coded in field coding in the second pass as well.

In another embodiment, the second MPEG-4 AVC encoding module 120 may reuse a full-pel ME result (or results) from the first pass. The second MPEG-4 AVC encoding module uses a simplified ME process. For each inter-prediction mode (inter_{—}16×16, inter_{—}16×8, inter_{—}8×16, inter_{—}8×8), the second pass uses the full-pel ME results from the first pass as a start point, and performs both full-pel ME refinement and quarter-pel ME refinement in a local area.

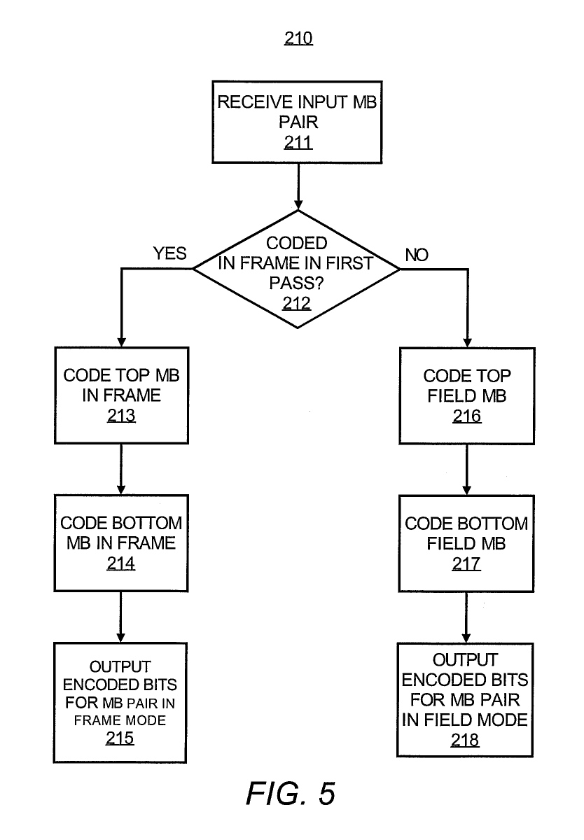

In the method 210, as shown in FIG. 5, the second MPEG-4 AVC encoding module 120 reuses the picAFF decision and an MBAFF decision from the first pass. Although not shown in FIG. 5, the method 210 may follow from the method 200, wherein the reuse of the picAFF decision is illustrated. The method 210 may be applied to an input picture coded in frame coding in the first pass, as described hereinabove with respect to step 203 of the method 200.

At step 211, the second MPEG-4 AVC encoding module 120 receives an input MB pair. The input MB pair is a part of the input video sequence received with a delay at the second MPEG-4 AVC encoding module 120.

At step 212, the second MPEG-4 AVC encoding module 120 determines whether the input MB pair was encoded in frame coding in the first pass. Determining whether the input MB pair was encoded in frame coding in the first pass may include receiving the coding decisions in the first pass from the first MPEG-4 AVC encoding module 110.

At step 213, if the input MB pair was coded in frame coding in the first pass, the second MPEG-4 AVC encoding module 120 codes a top MB of the MB pair in frame coding in the second pass as well. Similarly, at step 214, the second MPEG-4 AVC encoding module 120 codes a bottom MB of the MB pair in frame coding as well. Other coding decisions at lower levels are the same as in the first pass. The second MPEG-4 AVC encoding module 120 thereafter outputs the encoded bits for a frame MB pair at step 215.

If the input MB pair was not coded in frame coding in the first pass, the second MPEG-4 AVC encoding module 120 divides the MB into a top-field MB and a bottom-field MB. At step 216, the second encoding module then codes the top-field MB in the second pass. Similarly, at step 217, the second MPEG-4 AVC encoding module 120 codes the bottom-field MB as well. Other coding decisions at lower levels are the same as in the first pass. The second MPEG-4 AVC encoding module 120 thereafter outputs the encoded bits for the MB pair in field mode at step 218.

According to an embodiment, other coding decisions at lower levels are the same as in the first pass. Alternately, the second MPEG-4 AVC encoding module 120 may reuse a full-pel ME results from the first pass. The second MPEG-4 AVC encoding module uses a simplified ME process. For each inter-prediction mode (inter_{—}16×16, inter_{—}16×8, inter_{—}8×16, inter_{—}8×8), the second pass uses the full-pel ME result from the first pass as the start point, and performs both full-pel ME refinement and quarter-pel ME refinement in a local area.

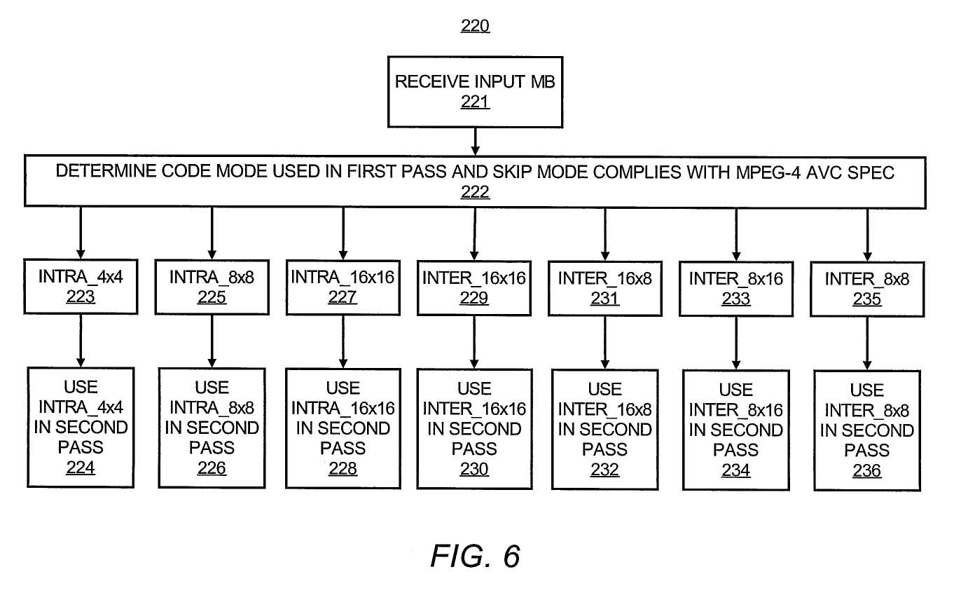

In the method 220, as shown in FIG. 6, the second MPEG-4 AVC encoding module 120 reuses the picAFF decision, the MBAFF decision and an MB mode decision from the first pass for an I, P, or B picture. Although not shown in FIG. 6, the method 220 may follow from the methods 200 and 210, wherein the reuse of the picAFF decision and the MBAFF decision are illustrated. The method 220 shows the MB mode decision applied to input video sequence with the delay 102 if the input picture is coded in frame coding or field coding in the first pass, as described hereinabove with respect to the methods 200 and 210.

At step 221, the second MPEG-4 AVC encoding module 120 receives an input MB.

At step 222, the second MPEG-4 AVC encoding module 120 determines a coding mode used in the first pass. The coding mode from the first pass may be any of intra modes intra_{—}4×4, intra_{—}8×8 and intra_{—}16×16. The coding mode may also be taken from inter modes inter_{—}16×16, inter_{—}16×8, inter_{—}8×16, and inter_{—}8×8. After determining the coding mode, the second MPEG-4 AVC encoding module 120 determines whether skip mode complies with the H.264 spec.

At steps 223 to 235, the second MPEG-4 AVC encoding module 120 uses the coding mode from the first pass to encode the input MB of the input picture of the input video sequence with the delay 102 in the second pass. Please note that steps 223 to 235 of FIG. 6 illustrate alternate coding mode determinations. For instance, if the second MPEG-4 AVC encoding module 120 determines after step 222 that the coding mode used for the MB in the first pass was intra_{—}16×16 at step 227, the second MPEG-4 AVC encoding module 120 uses intra_{—}16×16 to further encode the MB the second pass at step 228. Other coding mode determinations are in that instance excluded.

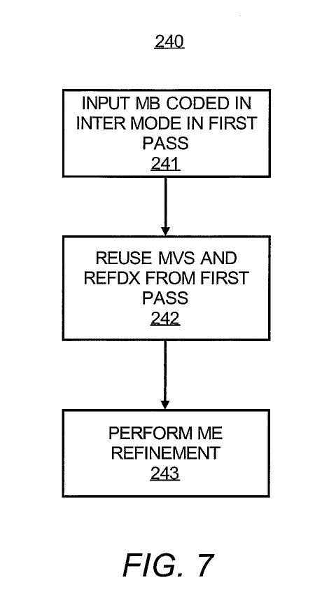

In the method 240, as shown in FIG. 7, the second MPEG-4 AVC encoding module 120 reuses the picAFF decision, the MBAFF, the MB mode decisions and full-pel ME results from the first pass for an I, P, or B picture. Although not shown in FIG. 7, the method 240 may follow from the methods 200, 210 and 220, wherein the reuse of the picAFF decision, the MBAFF decision, and the MB mode decisions are illustrated. The method 240 may be applied to an input MB of the input video sequence with the delay 102 if the input MB in inter mode in the first pass, as described hereinabove with respect to the method 220.

At step 241, the second MPEG-4 AVC encoding module 120 determines that the input MB was coded in inter mode in the first pass.

At step 242, the second MPEG-4 AVC encoding module 120 reuses MVs and refldx from the first pass as starting point for the input MB in the second pass.

At step 243, the second MPEG-4 AVC encoding module 120 may further refine the MVs within a small local area for the input MB. For instance, the second MPEG-4 AVC encoding module 120 may determine whether a coding cost with reuse of the MVs and refldx from the first pass is greater than a threshold. In response to a determination that the coding cost, for instance a non-RD cost, with reuse of the MVs and refldx from the first pass is greater than the threshold, the second MPEG-4 AVC encoding module 120 may refine the MVs within a local area in the picture.

### 5. First Pass Partial Encoder Second Pass Full Encoder

In the second embodiment, as described with respect to the methods 300 and 310, the two-pass MPEG-4 AVC encoder 100 is configured with the first MPEG-4 AVC encoding module 110 as a partial encoder and the second MPEG-4 AVC encoding module 120 as a full encoder. The methods 300 and 310 pertain to the first pass performed by the first MPEG-4 AVC encoding module 110. The second pass performed by the second MPEG-4 AVC encoding module 120 is a full pass, similar to the first pass described with respect to the first embodiment hereinabove. In the methods 300, and 310 the first MPEG-4 AVC encoding module 110 is configured as a simplified MPEG-4 AVC encoder, performing only full-pel ME per MB partition in inter mode. The full-pel ME cost is used in coding mode decisions, including a frame/field decision at both picture and MB pair levels, and the coding mode decision at MB level.

The first encoding module encodes an input picture in both frame and field mode as described in the method 300 and the method 310, respectively.

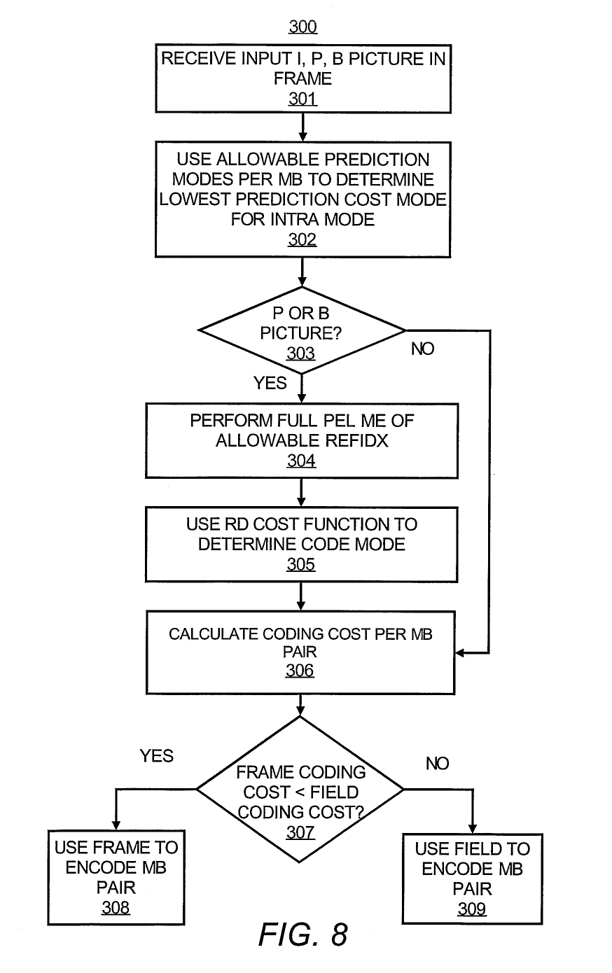

In the method 300, as described with respect to FIG. 8, the first MPEG-4 AVC encoding module 110 is configured to determine coding cost for both frame coding and field coding per MB pair for the picture in frame mode. The following steps 301 to 305 are performed therefore for both frame coding and field coding per MB pair. The procedure for the first pass is described as follows.

At step 301, the first MPEG-4 AVC encoding module 110 receives an input I, P, or B picture in frame.

At step 302, the first MPEG-4 AVC encoding module 110 is configured to use all allowable intra prediction modes per MB and to determine a lowest prediction cost mode for intra mode per MB. The lowest prediction cost mode is the allowable prediction mode with minimum RD cost function for each of intra 4×4, intra 8×8, and intra 16×16.

At step 303, the first MPEG-4 AVC encoding module 110 is configured to determine whether the input picture is a P or B picture. An input I picture is not coded in inter mode.

At step 304, if the input picture is a P or B picture, the first MPEG-4 AVC encoding module 110 is configured to perform full-pel ME of all allowable refldx per MB. The first MPEG-4 AVC encoding module 110 thereby determines a full-pel MV(s) and associated refldx with a minimum non-RD cost function for each of inter 16×16, inter 16×8, inter 8×16, and inter 8×8.

At step 305, the first MPEG-4 AVC encoding module 110 uses the RD cost function to determine a coding mode from intra 4×4, intra 8×8, intra 16×16, inter 16×16, inter 16×8, inter 8×16, inter 8×8, skip for P, and direct mode and skip for B.

At step 306, the first MPEG-4 AVC encoding module 110 calculates a coding cost per MB pair. For instance, the first MPEG-4 AVC encoding module 110 may sum up the coding costs of two MBs of an MB pair in frame and field to form coding costs for the MB pair in frame and field modes, respectively.

At step 307, the first MPEG-4 AVC encoding module 110 determines whether the coding cost for the MB pair in frame is lower than the coding cost in field.

At step 308, in response to a determination at step 307 that the coding cost for an MB pair in frame is lower than the coding cost in field, the first MPEG-4 AVC encoding module 110 uses frame coding to encode the MB pair.

At step 309, in response to a determination at step 307 that the coding cost for an MB pair in frame is not lower than the coding cost in field, the first MPEG-4 AVC encoding module 110 uses field coding to encode the MB pair.

The coding costs of all the MB pairs of the picture are added together to form a coding cost for the picture in frame mode.

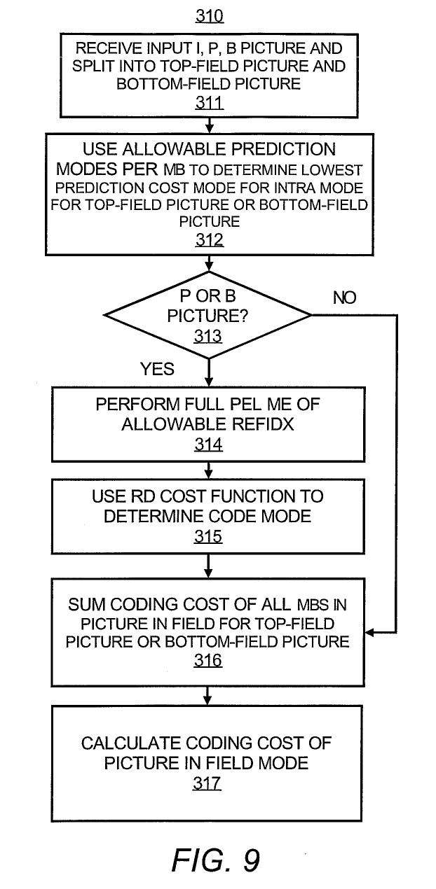

In the method 310, as described with respect to FIG. 9, the first MPEG-4 AVC encoding module 110 is configured to split the input picture into a top-field picture and a bottom-field picture. The first MPEG-4 AVC encoding module 110 is configured to determine coding cost for both the top-field picture and the bottom-field picture. The following steps 311 to 315 are performed therefore for both the top-field picture and the bottom-field picture. The procedure for the first pass in the method 310 is described as follows.

At step 311, the first MPEG-4 AVC encoding module 110 receives an input I, P, or B picture. The first MPEG-4 AVC encoding module 110 thereafter splits the input picture into a top-field picture and the bottom-field picture. The steps 312 to 315 hereinbelow may be performed for the picture in top-field or bottom-field.

At step 312, the first MPEG-4 AVC encoding module 110 is configured to use all allowable intra prediction modes per MB and to determine a lowest prediction cost mode for intra mode per MB. The lowest prediction cost mode is the allowable prediction mode with minimum RD cost function for each of intra 4×4, intra 8×8, and intra 16×16.

At step 313, the first MPEG-4 AVC encoding module 110 is configured to determine whether the input picture is a P or B picture. An input I picture is not coded in inter mode.

At step 314, if the input picture is a P or B picture, the first MPEG-4 AVC encoding module 110 is configured to perform full-pel ME of all allowable refldx per MB. The first MPEG-4 AVC encoding module 110 thereby determines a full-pel MV(s) and associated refldx with a minimum non-RD cost function for each of inter 16×16, inter 16×8, inter 8×16, and inter 8×8.

At step 315, the first MPEG-4 AVC encoding module 110 uses the RD cost function to determine a coding mode from intra 4×4, intra 8×8, intra 16×16, inter 16×16, inter 16×8, inter 8×16, inter 8×8, skip for P, and direct mode and skip for B.

At step 316, the first MPEG-4 AVC encoding module 110 sums up the coding costs of all MBs of the picture in top-field or bottom-field to form the coding cost for the picture in top-field or in bottom-field.

At step 317, the first MPEG-4 AVC encoding module 110 calculates a coding cost of the picture in field mode. For instance, the MPEG-4 AVC encoding module 110 may add the coding costs of the top-field picture and the bottom-field picture to form a coding cost for the picture in field mode.

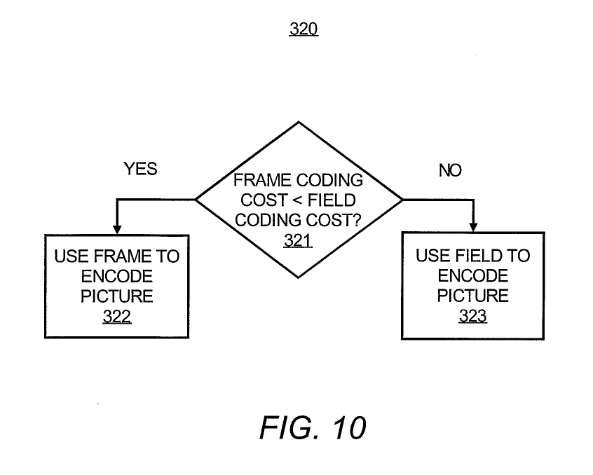

In the method 320, as described with respect to FIG. 10, the first MPEG-4 AVC encoding module 110 determines whether the coding cost for the picture in frame is lower than the coding cost for the picture in field and uses the lower cost mode to encode the picture.

At step 321, the first MPEG-4 AVC encoding module 110 determines whether the coding cost for the picture in frame mode is lower than the coding cost for the picture in field mode.

At step 322, in response to a determination at step 321 that the coding cost for the picture in frame mode is lower than the coding cost for the picture in field, the first MPEG-4 AVC encoding module 110 uses frame coding to encode the picture.

At step 323, in response to a determination at step 321 that the coding cost for the picture in frame mode is not lower than the coding cost for the picture in field mode, the first MPEG-4 AVC encoding module 110 uses field coding to encode the picture.

### 6. First Pass Partial Encoder Second Pass Partial Encoder

In the third embodiment, as described with respect to the method 400, the two-pass MPEG-4 AVC encoder 100 is configured with both the first MPEG-4 AVC encoding module 110 and the second MPEG-4 AVC encoding module 120 as a partial encoders. In the method 400, the first MPEG-4 AVC encoding module 110 is configured as a partial MPEG-4 AVC encoder, performing only full-pel ME per MB partition in inter mode. The full-pel ME cost is used in coding mode decisions in the first pass, including a frame/field decision at both picture and MB pair levels, and the coding mode decision at MB level. Instead of a full ME process per partition per refldx in the second pass, the second MPEG-4 AVC encoding module 120 is configured to perform ME refinement around a full-pel MV(s) from the first pass, or use a full-pel MV(s) from the first pass as a starting point for ME refinement.

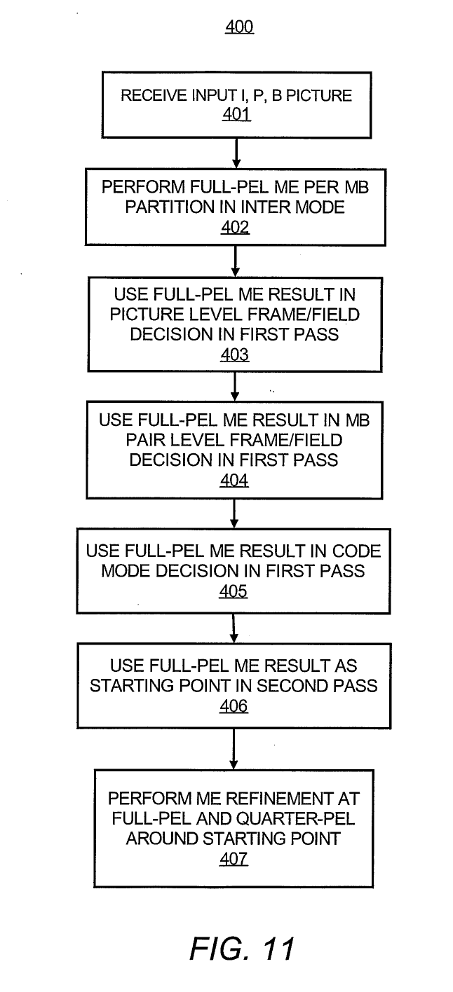

At step 401, as described with respect to FIG. 11, the first MPEG-4 AVC encoding module 110 receives an input I, P, or B picture.

At step 402, the first MPEG-4 AVC encoding module is configured to perform full-pel ME per MB partition in inter mode to determine a full-pel ME costs and a full-pel MV(s) in the first pass.

At step 403, the first MPEG-4 AVC encoding module is configured to use the full-pel ME costs to determine a frame/field decision at a picture level.

At step 404, the first MPEG-4 AVC encoding module is configured to use the full-pel ME costs to determine a frame/field decision at an MB pair level for a picture in frame mode.

At step 405, the first MPEG-4 AVC encoding module is configured to use the full-pel ME costs to determine a coding mode decision at an MB level.

At step 406, the second MPEG-4 AVC encoding module is configured to use the full-pel ME results as starting points for ME in the second pass (both full-pel and quarter-pel) of each of inter modes inter_{—}16×16, inter_{—}16×8, inter_{—}8×16, and inter_{—}8×8.

At step 407, the second MPEG-4 AVC encoding module is configured to perform ME refinement at quarter-pel level around the full-pel MV(s) from the first pass.

There may be different levels of information reuse in the second pass. According to an embodiment, the second MPEG-4 AVC encoding module may reuse a picAFF decision from the first pass in the second pass. According to another embodiment, the second MPEG-4 AVC encoding module may reuse both the picAFF decision and an MBAFF decision from the first pass in the second pass.

### 7. Switching Between Embodiments of the Two-Pass MPEG AVC Encoder

The two-pass MPEG-4 AVC encoder 100 may be configured to switch between embodiments. For instance, the two-pass MPEG-4 AVC encoder 100 may be configured to switch between embodiments based on a combination of factors including a complexity of the input video sequence, a combined processing load and an end user decision. Additionally, the two-pass MPEG-4 AVC encoder 100 may be configured to switch to an embodiment having two full MPEG-4 AVC encoders in situations in which quality is the major factor. The two-pass MPEG-4 AVC encoder 100 may be configured to switch on a per picture basis or at a beginning of an encoding pass for the entire encoding pass in both MPEG-4 AVC encoders of the two-pass MPEG-4 AVC encoder 100.

### 8. Computing Apparatus for Two-Pass MPEG AVC Encoder

A computing apparatus (not shown) may be configured to implement or execute one or more of the processes required to two-pass encode an input video sequence depicted in FIGS. 3-11, according to an embodiment. The computing apparatus may include a processor that may implement or execute some or all of the steps described in the method depicted in FIGS. 3-11.

Commands and data from the processor may be communicated over a communication bus. The computing apparatus may also include a main memory, such as a random access memory (RAM), where the program code for the processor, may be executed during runtime, and a secondary memory. The secondary memory includes, for example, one or more hard disk drives and/or a removable storage drive, representing a floppy diskette drive, a magnetic tape drive, a compact disk drive, etc., where a copy of the program code for one or more of the processes depicted in FIGS. 3-11 may be stored. In addition, the processor(s) may communicate over a network, for instance, the Internet, LAN, etc., through a network adaptor.

Embodiments of the present invention include a two-pass MPEG-4 AVC encoder that provides a balance between performance of a conventional two-pass encoder and comparatively low complexity of a single pass encoder. Embodiments of the invention may be used to provide rate control with a delay between a first pass and a second pass. By using the delay, coding statistics from the first pass may be used in determining target coding parameters for the second pass for rate control purposes. Additionally, because of the use of the coding statistics, which includes decisions on coding modes and MVs for MPEG-4 AVC, partial encoding used in the first pass or the second pass significantly reduces the encoding costs when compared to a conventional two-pass encoder while providing a similar coding performance. For example, instead of using an RD cost function, a non-RD cost function can be used to select coding modes. The non-RD cost function needs less information to determine costs and also uses much less resources than the RD cost function. Furthermore, the performance, even when using the non-RD cost function as opposed to the RD cost function, has accuracy that is very close to a two-pass MPEG-4 AVC encoder comprised of two full MPEG-4 AVC encoders. Furthermore, accuracy for ME is increased by using a result of full-pel ME in a first pass as a starting point for performing ME refinement in the second pass.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

What is claimed is:

1. A two-pass encoder to encode an input video sequence to form a stream, the two-pass encoder comprising:
a first encoding module including a circuit configured
to encode the input video sequence in a first pass, and
to determine coding decisions from the first pass and to output the coding decisions from the first pass;
a second encoding module configured
to receive the coding decisions output from the first pass;
to encode the input video sequence using the coding decisions from the first encoding module in a second pass, and
to output a second pass encoded stream; and
wherein at least one of the first encoding module and the second encoding module is a partial encoding module and the input video sequence is received at the first encoding module and with a delay at the second encoding module.

2. The two-pass encoder of claim 1, wherein the first encoding module is a full encoding module and the second encoding module is a partial encoding module.

3. The two-pass encoder of claim 2, wherein the coding decisions include reuse of a picAFF decision from the first pass for an I, P, or B picture, and
in response to a picture being coded in frame in the first pass,
the second encoding module is configured to code the picture in frame in the second pass; and
in response to the picture being coded in field in the first pass,
the second encoding module is configured to code the picture in field in the second pass.

4. The two-pass encoder of claim 3, wherein the coding decisions include reuse an MBAFF decision from the first pass for an MB pair in the picture in frame, and
in response to the picture being coded in frame and the MB pair being coded in frame in the first pass,
the second encoding module is configured to code the MB pair in frame in the second pass; and
in response to the picture being coded in frame and the MB pair being coded in field in the first pass,
the second encoding module is configured to code the MB pair in field in the second pass.

5. The two-pass encoder of claim 4, wherein the coding decisions include reuse of an MB mode decision from the first pass for the MB pair, and
in response to the picture being coded in frame and the MB pair being coded in frame in the first pass, or in response to the picture being coded in frame and the MB pair being coded in field in the first pass, or in response to the picture being coded in field,
the second encoding module is configured to reuse the MB mode decision in the second pass.

6. The two-pass encoder of claim 5, wherein the coding decisions include reuse of MVs and refldx from the first pass,
in response to the MB being coded in inter mode in the first pass, the second encoding module is configured
to reuse MVs and refldx from the first pass in the second pass,
to determine whether a coding cost with reuse of the MVs and refldx is greater than a threshold, and in response to a determination that the coding cost with reuse of the MVs and refldx is greater than the threshold, to refine the MVs within a local area in the picture, and
to determine whether skip mode complies with the MPEG-4 AVC specification.

7. The two-pass encoder of claim 3, wherein the coding decisions include use of a full-pel ME results from the first pass in the second pass, and
the second encoding module is configured to use a full-pel ME result from the first pass as a starting point and to perform both full-pel ME refinement and quarter-pel ME refinement in a local area in the picture.

8. The two-pass encoder of claim 4, wherein the coding decisions include use of a full-pel ME result from the first pass in the second pass, and
the second encoding module is configured to use a full-pel ME result from the first pass as a starting point and to perform both full-pel ME refinement and quarter-pel ME refinement in a local area in the picture.

9. The two-pass encoder of claim 1, wherein the first encoding module is a partial encoding module and the second encoding module is a full encoding module.

10. The two-pass encoder of claim 9, wherein the first encoding module is configured to:
determine for frame coding and field coding at an MB pair level,
in response to an input I, P, or B picture, to use all allowable prediction modes per MB and determine a lowest prediction cost mode for intra mode per MB, wherein the lowest prediction cost mode is the allowable prediction mode with minimum RD cost function for each of intra 4×4, intra 8×8, and intra 16×16,
in response to an input P, or B picture, to perform full-pel ME of all allowable refldx per MB and determine a full-pel MV(s) and associated refldx with a minimum non-RD cost function for each of inter 16×16, inter 16×8, inter 8×16, inter 8×8,
to use the RD cost function to determine a coding mode from of intra 4×4, intra 8×8, intra 16×16, inter 16×16, inter 16×8, inter 8×16, inter 8×8, skip for P, and direct mode and skip for B;
calculate a coding cost for the MB pair in both frame and field;
determine whether the coding cost for the MB pair in frame is lower than the coding cost for the MB pair in field; and
in response to a determination that the coding cost for the MB pair in frame is lower than the coding cost for the MB pair in field, use frame coding to encode the MB pair, and
in response to a determination that the coding cost for the MB pair in frame is not lower than the coding cost for the MB pair in field, use field coding to encode the MB pair.

11. The two-pass encoder of claim 9, wherein the first encoding module is configured to:
determine field coding for both a top field picture and a bottom field picture
in response to an input I, P, or B picture, to use all allowable prediction modes per MB and determine a lowest prediction cost mode for intra mode per MB, wherein the lowest prediction cost mode is the allowable prediction mode with minimum RD cost function for each of intra 4×4, intra 8×8, and intra 16×16,
in response to an input P, or B picture, to perform full-pel ME of all allowable refldx per MB and determine a full-pel MV(s) and associated refldx with a minimum non-RD cost function for each of inter 16×16, inter 16×8, inter 8×16, inter 8×8,
to use the RD cost function to determine a coding mode from of intra 4×4, intra 8×8, intra 16×16, inter 16×16, inter 16×8, inter 8×16, inter 8×8, skip for P, and direct mode and skip for B, and
calculate a coding cost per for the picture in top field and bottom field.

12. The two-pass encoder of claim 1, wherein the first encoding module is a partial encoding module and the second encoder is a partial encoding module.

13. The two-pass encoder of claim 12, wherein
the first encoding module is configured to
perform full-pel ME per MB partition in inter mode to determine a full-pel ME costs and a full-pel MV(s) in the first pass, and
use the full-pel ME costs to determine a frame/field decision at a picture level,
use the full-pel ME costs to determine a frame/field decision at an MB pair level, and
use the full-pel ME costs to determine a coding mode decision at an MB level; and
the second encoding module is configured to
use the full-pel ME costs as a starting points,
perform ME refinement at full-pel level and quarter-pel level around the full-pel MV(s) from the first pass.

14. The two-pass encoder of claim 13, wherein
the second encoding module is further configured to reuse the frame/field decision at the picture level, and the frame/field decision at the MB pair level, in the second pass.

15. The two-pass encoder of claim 13, wherein
the second encoding module is further configured to
use the full-pel ME result from the first pass as the starting points for each of inter modes inter_{—}16×16, inter_{—}16×8, inter_{—}8×16, and inter_{—}8×8,
perform full-pel ME refinement and quarter-pel ME refinement around the starting points.

16. The two-pass encoder of claim 13, wherein the second encoding module is further configured to reuse a picAFF decision from the first pass for any of an I, P, and B picture.

17. The two-pass encoder of claim 13, wherein the second encoding module is further configured to reuse a picAFF decision and an MBAFF decision from the first pass for any of an I, P, and B picture.

18. The two-pass encoder of claim 1, wherein the two-pass encoder is further configured to switch between a first pass full encoder second pass full encoder configuration, a first pass full encoder second pass partial encoder configuration, a first pass partial encoder second pass full encoder configuration and a first pass partial encoder second pass partial encoder configuration based on processing load.

19. A method for two-pass encoding an input video sequence to form a second pass encoded stream, the method comprising:
encoding the input video sequence in a first pass using a first encoding module;
determining coding decisions from the first pass
outputting the coding decisions from the first pass;
receiving the coding decisions from the first pass at a second encoding module;
encoding the input video sequence using the coding decisions from the first pass in a second pass;
outputting a second pass encoded stream; and
wherein at least one of the first encoding module and the second encoding module is a partial encoding module and the input video sequence is received at the first encoding module and with a delay at the second encoding module.

20. The method of claim 19, wherein the method further comprises:
reusing a picAFF decision from the first pass for an I, P, or B picture wherein, in response to a picture being coded in frame in the first pass,
the second encoding module is configured to code the picture in frame in the second pass;
in response to the picture being coded in field in the first pass,
the second encoding module is configured to code the picture in field in the second pass; and
wherein the first encoding module is a full encoding module and the second encoding module is a partial encoding module.

21. The method of claim 19, wherein the method further comprises:
determining for both frame coding and field coding for an MB pair,
in response to an input I, P, or B picture, using all allowable prediction modes per MB and determining a lowest prediction cost mode for intra mode per MB, wherein the lowest prediction cost mode is the allowable prediction mode with minimum RD cost function for each of intra 4×4, intra 8×8, and intra 16×16,
in response to an input P, or B picture, performing full-pel ME of all allowable refldx per MB and determining a full-pel MV(s) and associated refldx with a minimum non-RD cost function for each of inter 16×16, inter 16×8, inter 8×16, inter 8×8,
using the RD cost function to determine a coding mode from of intra 4×4, intra 8×8, intra 16×16, inter 16×16, inter 16×8, inter 8×16, inter 8×8, skip for P, and direct mode and skip for B;
calculating a coding cost for an MB pair in both frame and field;
determining whether the coding cost for the MB pair in frame is lower than the coding cost for the MB pair in field; and
in response to a determination that the coding cost for the MB pair in frame is lower than the coding cost for the MB pair in field, using frame coding to encode the MB pair, and
in response to a determination that the coding cost for the MB pair in frame is not lower than the coding cost for the MB pair in field, using field coding to encode the MB pair. and
wherein the first encoding module is a partial encoding module and the second encoding module is a full encoding module.
